(19) United States
(12) Patent Application Publication
(10) Pub. No.: US 2025/0174695 A1
(43) Pub. Date: May 29, 2025

(54) ELECTROLYTE FOR ORGANIC REDOX FLOW BATTERIES AND ORGANIC REDOX FLOW BATTERIES COMPRISING THE SAME

(71) Applicant: SEOUL NATIONAL UNIVERSITY R&DB FOUNDATION, Seoul (KR)

(72) Inventors: Youngsu KIM, Seoul (KR); Kisuk KANG, Seoul (KR)

(21) Appl. No.: 18/669,412

(22) Filed: May 20, 2024

(30) Foreign Application Priority Data
Nov. 23, 2023 (KR) 10-2023-0163993

(51) Int. Cl. H01M 8/18; H01M 4/90

(52) U.S. Cl. CPC H01M 8/188; H01M 4/9008

(57) ABSTRACT

Provided is an electrolyte for an organic redox flow battery, which is capable of increasing the solubility of an organic electrode active material with respect to an electrolyte through micelle solubilization. According to an aspect of the present invention, provided is an electrolyte for an organic redox flow battery, which includes an organic electrode active material, a solvent, and a surfactant.

### CROSS-REFERENCE TO RELATED APPLICATION

This application claims priority to Korean Patent Application No. 10-2023-0163993, filed on Nov. 23, 2023, and all the benefits accruing therefrom under 35 U.S.C. § 119, the contents of which are incorporated by reference in their entirety.

### BACKGROUND

The present disclosure relates to an electrolyte for an organic redox flow battery, and more particularly, to an electrolyte for an organic redox flow battery and an organic redox flow battery including the same.

Depletion of fossil fuels and intensified global warming have induced a rapid spike in demand for new renewable energy since the 2000s. However, the new renewable energy is limited in time for generation, and accordingly, research has been conducted on devices capable of storing large amounts of energy for constant use. In particular, redox flow batteries, unlike typical lithium-ion batteries exhibiting a trade-off between energy and output, have electrode active materials dissolved in electrolytes, and thus are provided with separate portions including a portion storing electrode active materials and a portion having electrochemical reactions, and are capable of independently controlling energy and output, which are key to performance in secondary batteries, by adjusting the volume and area of each portion. Accordingly, research on applying redox flow batteries to large-capacity energy storage devices such as Energy storage system (ESS) has continued.

In the research on redox flow batteries, several studies have been conducted to increase energy density, which is one of the critical factors for the performance of batteries, and in particular, a method of introducing a functional group that improves solubility suitable for electrode active materials is most widely used. For example, an aqueous organic redox flow battery using water as a solvent involves a method of introducing a hydrophilic functional group such as a hydroxy group (—OH), a trimethylammonium group (—N(CH₃)₃⁺), or a sulfonate group (—SO₃⁻) into an electrode active material. In addition, a non-aqueous organic redox flow battery using an organic solvent involves a method of introducing a functional group such as an oligomeric ethylene glycol group (—(OCH₂CH₂)ₙOH) to control solubility in general.

However, these methods require additional processes, which need to be newly designed for each molecule to be synthesized, in a process of synthesizing organic electrode active materials, resulting in additional costs, and thus become uneconomical.

### SUMMARY

The present disclosure provides an electrolyte for an organic redox flow battery, which is capable of increasing the solubility of an organic electrode active material with respect to an electrolyte through micelle solubilization.

The present disclosure also provides an electrolyte for an organic redox flow battery, which is capable of skipping a complicated synthesis process required when introducing a hydrophilic group into a typical organic electrode active material and significantly reducing manufacturing costs.

The present disclosure also provides an electrolyte for an organic redox flow battery, which is capable of significantly increasing the capacity of a reversible organic redox flow battery.

The present disclosure also provides an organic redox flow battery including the electrolyte for an organic redox flow battery.

Aspects of the present disclosure are not limited to the above-described aspects, and other tasks and benefits of the present disclosure which are not described may be appreciated from the following descriptions, and more clearly appreciated from embodiments of the present disclosure. Further, it will be easily appreciated that the aspects and benefits of the present disclosure may be practiced by means recited in the specification and a combination thereof.

According to a first aspect of the present invention, provided is an electrolyte for an organic redox flow battery, which includes an organic electrode active material, a solvent, and a surfactant.

According to a second aspect of the present invention, as set forth in the first aspect of the invention, the organic electrode active material may include at least one selected from a 2,2,6,6-tetramethylpiperidin-1-yl)oxyl-based (TEMPO-based) compound, ferrocene, and phenazine.

According to a third aspect of the present invention, as set forth in the second aspect of the invention, the TEMPO-based compound may include at least one selected from the group consisting of 2,2,6,6-tetramethylpiperidin-1-yl)oxyl (TEMPO), 4-methacryloyloxy-2,2,6,6-tetramethylpiperidine-1-oxyl (4-methacryloyloxy TEMPO), 4-amino-2,2,6,6-tetramethylpiperidine-1-oxyl (4-amino TEMPO), 4-acetamido-2,2,6,6-tetramethylpiperidine-1-oxyl (4-acetamido TEMPO), and 4-oxo-2,2,6,6-tetramethylpiperidine-1-oxyl (4-oxo TEMPO).

According to a fourth aspect of the present invention, as set forth in any one of the first to third aspects of the invention, the organic electrode active material may have a solubility of 0.1 M or greater.

According to a fifth aspect of the present invention, as set forth in any one of the first to fourth aspects of the invention, the solvent may include any one selected from the group consisting of an aqueous solvent, a non-aqueous solvent, and a mixture thereof.

According to a sixth aspect of the present invention, as set forth in any one of the first to fifth aspects of the invention, the surfactant may include at least one selected from the group consisting of a cationic surfactant, an anionic surfactant, and a nonionic surfactant.

According to a seventh aspect of the present invention, as set forth in any one of the first to sixth aspects of the invention, the surfactant may include a cationic surfactant.

According to an eighth aspect of the present invention, as set forth in any one of the first to seventh aspects of the invention, the cationic surfactant may include a quaternary ammonium salt.

According to a ninth aspect of the present invention, as set forth in any one of the first to eighth aspects of the invention, the surfactant may have a concentration of 0.1 M or greater.

According to a tenth aspect of the present invention, provided is an organic redox flow battery including the electrolyte for an organic redox flow battery according to any one of the first to ninth aspects.

The means for addressing the above tasks do not present all the characteristics of the present invention. The various characteristics of the present invention and benefits and effects thereof may be understood in more detail with reference to specific descriptions below.

### BRIEF DESCRIPTION OF THE DRAWINGS

Exemplary embodiments can be understood in more detail from the following description taken in conjunction with the accompanying drawings, in which:

FIG. 1 is a schematic view of an organic redox flow battery according to an embodiment of the present invention;

FIG. 2A shows the solubility of TEMPO according to the concentration of CTAC;

FIG. 2B shows the UV-vis spectrum of TEMPO for electrolytes according to Comparative Example and Examples 4 to 6;

FIG. 3 shows cyclic voltammetry curves according to electrolytes of each of Comparative Example and Examples 1 to 3; and

FIG. 4 shows the performance of organic redox flow batteries according to each of Comparative Example and Examples 1 to 3.

### DETAILED DESCRIPTION OF EMBODIMENTS

As used herein, the terms of a singular form may include a plural form unless the context clearly indicates otherwise.

When multiple embodiments are described in the specification, effects of the present invention may be defined to include both a functional effect resulting from each embodiment itself and an effect resulting from organically combining embodiments. For example, even when Embodiments 1 and 2 are described independently in the specification, unless the context clearly indicates otherwise, the effects resulting from organically combining Embodiments 1 and 2 may also be included in the effects of the present invention.

Herein, the numerical range indicated by using “to” represents a numerical range including the values described therebefore and thereafter as a lower limit and an upper limit, respectively. When a plurality of numerical values each for the upper and lower limits of any numerical range are disclosed, the numerical range disclosed herein may be understood as any numerical range in which any one of the plurality of lower limit values and any one of the plurality of upper limit values are each set as a lower limit and an upper limit. For example, when a to b, or c to d are described in the specification, it may be understood that a or greater and d or less, c or greater and d or less, or c or greater and b or less are described.

Terms such as “about” or “substantially” as used herein mean a reasonable amount of deviation of the modified term such that the end result is not significantly changed. These terms should be construed as including a deviation of at least ±5% or at least ±10% of the modified term if this deviation would not negate the meaning of the word it modifies.

According to an aspect of the present invention, provided is an electrolyte for an organic redox flow battery, which includes an organic electrode active material, a solvent, and a surfactant.

Typically, a method of introducing a functional group has been used to improve the solubility of organic electrode active materials. For example, as for an aqueous organic redox flow battery using water as a solvent, a hydrophilic functional group such as a hydroxy group (—OH), a trimethylammonium group (—N(CH3)3+), or a sulfonate group (—SO3−) is introduced into an electrode active material to increase the solubility of organic electrode active materials with respect to electrolytes. In addition, a non-aqueous organic redox flow battery using an organic solvent involves a method of introducing a functional group such as an oligomeric ethylene glycol (—(OCH2CH2)nOH) group to control solubility in general. However, these methods require additional several processes, which need to be newly designed for each molecule to be synthesized, in the synthesis process of organic materials, resulting in additional costs, and thus become uneconomical.

According to an aspect of the present invention, an organic electrode active material, a solvent, and a surfactant are included, and thus both a hydrophilic portion and a hydrophobic portion are present in one molecule to provide an environment with opposite properties for each solvent inside micelles through the surfactant forming the micelles above a certain concentration, resulting in further greater solubility of organic electrode active materials that do not dissolve well in the solvent (micelle solubilization).

According to another aspect of the present invention, an organic electrode active material, a solvent, and a surfactant are included, and thus the solubility of organic electrode active materials with respect to the solvent, is increased, resulting in significantly increased capacity of a reversible organic redox flow battery.

### 1. Electrolyte for Organic Redox Flow Battery

An electrolyte for an organic redox flow battery according to the present invention includes an organic electrode active material, a solvent, and a surfactant.

### Organic Electrode Active Material

An organic electrode active material according to the present invention may be included in an electrolyte for an organic redox flow battery to allow charging and discharging through a reversible electrochemical reaction. Specifically, the organic electrode active material may be converted into a state between oxidization and reduction to generate or store electrical energy.

The organic electrode active material according to the present invention is a material that performs a reversible oxidation/reduction reaction with a carbon number of 1 or greater, 2 or greater, or 3 or greater, and may be distinguished from an inorganic electrode active material having no carbon in molecules.

For example, the organic electrode active material is not particularly limited and may be a variety of electrode active materials commonly used in the art. Specifically, the organic electrode active material may include at least one selected from a 2,2,6,6-tetramethylpiperidin-1-yl)oxyl-based (TEMPO-based) compound, ferrocene, and phenazine, and may more specifically include a 2,2,6,6-tetramethylpiperidin-1-yl)oxyl-based (TEMPO-based) compound.

For example, the TEMPO-based compound may include at least one selected from the group consisting of 2,2,6,6-tetramethylpiperidin-1-yl)oxyl (TEMPO), 4-methacryloyloxy-2,2,6,6-tetramethylpiperidine-1-oxyl (4-methacryloyloxy TEMPO), 4-amino-2,2,6,6-tetramethylpiperidine-1-oxyl (4-amino TEMPO), 4-acetamido-2,2,6,6-tetramethylpiperidine-1-oxyl (4-acetamido TEMPO), and 4-oxo-2,2,6,6-tetramethylpiperidine-1-oxyl (4-oxo TEMPO), and may specifically include 2,2,6,6-tetramethylpiperidin-1-yl)oxyl (TEMPO).

In some embodiments of the present invention, with respect to the total weight of the electrolyte for an organic redox flow battery, the organic electrode active material may be in an amount of 2.0 to 9.0 wt %, 2.9 to 8.7 wt %, 3.0 to 8.7 wt %, 4 to 8.7 wt %, 5 to 8.7 wt %, 6 to 8.7 wt %, 7 to 8.7 wt %, 8 to 8.7 wt %, 8.1 to 8.7 wt %, 8.2 to 8.7 wt %, 8.3 to 8.7 wt %, 8.4 to 8.7 wt %, 8.5 to 8.7 wt %, or 8.6 to 8.7 wt %. In some embodiments of the present invention, when the organic electrode active material is in an amount satisfying the above numerical range, the organic redox flow battery may have sufficiently increased energy density.

In some embodiments of the present invention, with respect to the electrolyte for an organic redox flow battery, the organic electrode active material may have a solubility of 0.2 M to 0.8 M or greater, specifically 0.75 to 0.85 M. In some embodiments of the present invention, when the solubility of the organic electrode active material satisfies the above numerical range, the organic redox flow battery may have further increased capacity.

### Solvent

A solvent according to the present invention may partially dissolve the organic electrode active material with respect to the electrolyte for an organic redox flow battery.

The solvent according to the present invention may include any one selected from the group consisting of an aqueous solvent, a non-aqueous solvent, and a mixture thereof, and may specifically include an aqueous solvent.

For example, the aqueous solvent is not particularly limited and may be a hydrophilic solvent commonly used in the art, and may specifically be any one selected from the group consisting of water, alcohol, an ethylene glycol-based compound, and a mixture thereof, and may more specifically be water. For example, the ethylene glycol-based compound may include any one or more of ethylene glycol and diethylene glycol.

For example, the non-aqueous solvent may include at least one selected from the group consisting of dimethyl acetamide, diethyl carbonate, dimethyl carbonate, propylene carbonate, ethylene carbonate, N-methyl-2-pyrrolidone, fluoroethylene carbonate, and N,N-dimethylacetamide.

In some embodiments of the present invention, with respect to the total weight of the electrolyte for an organic redox flow battery, the solvent may be in an amount of 60 wt % or greater, 60 to 98 wt %, 69 to 95 wt %, or 69.2 to 94.1 wt %. In some embodiments of the present invention, when the solvent is in an amount satisfying the above numerical range, the organic electrode active material has an appropriate level of solubility, and accordingly, the organic redox flow battery may have sufficiently increased capacity.

### Surfactant

A surfactant according to the present invention includes both a hydrophilic portion and a hydrophobic portion within molecules, and thus may interact with an organic electrode active material to form micelles. Specifically, the surfactant provides an environment with opposite properties for each solvent inside micelles to dissolve an organic electrode active material that does not dissolve well in the solvent, and may thus significantly increase the capacity of the organic redox flow battery.

The surfactant according to the present invention may include at least one selected from the group consisting of a cationic surfactant, an anionic surfactant, and a nonionic surfactant, and may specifically include a cationic surfactant, and may more specifically include a quaternary ammonium salt. In some embodiments of the present invention, when quaternary ammonium salt is used as the surfactant, the solubility of an organic electrode active material with respect to an aqueous solvent may be further increased.

For example, the quaternary ammonium salt may be a compound represented by General Formula 1 below.

NR4⁺X— [General Formula 1]

In General Formula 1 above, R may each independently be a hydrogen atom or an

alkyl group having 1 to 30 carbon atoms, and X may be a halogen atom. For example, the halogen atom may be chlorine or bromine.

For example, the quaternary ammonium salt may include at least any one of dodecyltrimethyl ammonium chloride, lauryltrimethyl ammonium chloride, hexadecyltrimethylammonium chloride, didodecyldimethyl ammonium bromide, dihexadecyldimethyl ammonium chloride, dihexadecyldimethyl ammonium bromide, dioctadecyldimethyl ammonium chloride, dieicosyldimethyl ammonium chloride, didocosyldimethyl ammonium chloride, dicoconut dimethyl ammonium chloride, ditallowdimethyl ammonium chloride, and ditallowdimethyl ammonium bromide.

For example, the anionic surfactant may be a compound whose molecules dissociate into anions in an aqueous solution, and may specifically include sulfonic acid and a salt derivative thereof, and may more specifically include sodium dodecylsulfate.

For example, the nonionic surfactant may be a compound whose molecules do not dissociate into ions in an aqueous solution, and may specifically include at least one selected from the group consisting of a nonionic surfactant (e.g., TX-100) having a hydrophilic polyethylene oxide chain (with an average of 9.5 ethylene oxide units) and aromatic hydrocarbon lipophilic or hydrophobic groups, 2,6,8-trimethyl-4-nonyloxy polyethylene oxyethanol, polyoxyethylene 23 lauryl ether, and polyoxyethylene ether alcohol.

In some embodiments of the present invention, with respect to the total volume of the electrolyte for an organic redox flow battery, the surfactant may have a concentration of 0.1 M or greater, 0.2 M or greater, 0.3 M or greater, 0.4 M or greater, 0.5 M or greater, 0.6 M or greater, 0.7 M or greater, 0.8 M or greater, 0.9 M or greater, or 1.0 M or greater, specifically 0.1 to 1.0 M, more specifically 0.2 to 1.0 M, 0.3 to 1.0 M, 0.4 to 1.0 M, 0.5 to 1.0 M, 0.6 to 1.0 M, 0.7 to 1.0 M, 0.8 to 1.0 M, or 0.9 to 1.0 M. Specifically, when the concentration of the surfactant satisfies the above numerical range, the surfactant interacts with an organic electrode active material to form micelles to further increase the solubility of the organic electrode active material with respect to an aqueous solvent, thereby further increasing the capacity of the organic redox flow battery.

### 2. Organic Redox Flow Battery

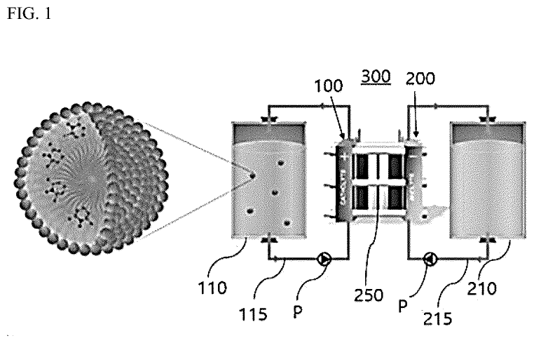

Hereinafter, components of the present invention will be described in detail with reference to FIG. 1.

FIG. 1 is a schematic view of an organic redox flow battery according to an embodiment of the present invention.

An organic redox flow battery 300 according to the present invention may include a positive electrode cell 100, a positive electrode electrolyte storage tank 110, a negative electrode cell 200, a negative electrode electrolyte storage tank 210, a pump P, a separator 250, and first and second connection portions 115 and 215.

The positive electrode cell 100 according to the present invention may store and generate electrical energy through oxidation/reduction reactions of organic positive electrode active materials. Specifically, the positive electrode cell 100 may include a positive electrode and a positive electrode electrolyte of some embodiments described above. In this case, the organic positive electrode active materials of some embodiments described above may be partially or entirely dissolved in the positive electrode electrolyte.

For example, the positive electrode is not particularly limited and may be formed of a common electrode material that provides an active site for oxidation/reduction of electrolytes. Specifically, the positive electrode may be formed of a material such as carbon non-woven fabric, carbon fiber, or carbon paper.

The positive electrode electrolyte storage tank 110 according to the present invention may supply the stored positive electrode electrolyte to the positive electrode cell 100. The first connection portion 115 commonly used in the art may be used as a means for supplying the stored positive electrode electrolyte. Power for supplying the stored positive electrode electrolyte may be implemented by the pump P provided in the first connection portion 115.

The negative electrode cell 200 according to the present invention may store and generate electrical energy through oxidation/reduction reactions of organic negative electrode active materials. Specifically, the negative electrode cell 200 may include a negative electrode and a negative electrode electrolyte described above.

For example, the negative electrode is not particularly limited and may be formed of a common electrode material that provides an active site for oxidation/reduction of electrolytes. Specifically, the negative electrode may be formed of a material such as carbon non-woven fabric, carbon fiber, or carbon paper.

The organic negative electrode active material according to the present invention is partially or entirely dissolved in the negative electrode electrolyte and is not particularly limited, and may specifically include at least any one of a viologen-based compound, a benzophenone-based compound, and a benzoquinone-based compound, and may specifically include a viologen-based compound.

The negative electrode electrolyte storage tank 210 according to the present invention may supply the stored negative electrode electrolyte to the negative electrode cell 200. The second connection portion 215 commonly used in the art may be used as a means for supplying the stored negative electrode electrolyte. Power for supplying the stored negative electrode electrolyte may be implemented by the pump P provided in the second connection portion 215.

The separator 250 according to the present invention may separate the positive electrode cell 100 and the negative electrode cell 200 and selectively move ions generated upon battery operation.

For example, the separator is not particularly limited and may include an ion exchange membrane commonly used in the art, and may specifically be a cation exchange membrane, an anion exchange membrane, or a porous separator.

Hereinafter, embodiments of the present invention will be described in detail so as to be easily carried out by a person skilled in the art to which the present invention pertains, but this is only presented as an example, and the scope of the present invention is not limited to the following features.

### MANUFACTURING PREPARATION EXAMPLE: PREPARATION OF MATERIALS

2,2,6,6-tetramethylpiperidin-1-yl)oxyl (TEMPO) was prepared as an organic positive electrode active material, and hexadecyltrimethylammonium chloride (CTAC), a cationic surfactant, was prepared as a surfactant.

### Preparation Example 1: Preparation of Electrolyte for Organic Redox Flow Battery

Electrolytes according to Comparative Example and Examples 1 to 3 having the compositions shown in Table 1 below were prepared. The volumes of the electrolytes of Comparative Example and Examples 1 to 3 below were 5.00 mL, 5.10 mL, 5.19 mL, and 5.26 mL, respectively.

TABLE 1

| | Comparative | | Example | | Example | | Example | |
|---|---|---|---|---|---|---|---|---|
| Item | Example | | 1 | | 2 | | 3 | |
| Water | 5 | mL | 5 | mL | 5 | mL | 5 | mL |
| Amount of | 0.0625 | g | 0.1563 | g | 0.3516 | g | 0.625 | g |
| organic positive | | | | | | | | |
| electrode active | | | | | | | | |
| material | | | | | | | | |
| (TEMPO) | | | | | | | | |
| Concentration of | — | | 0.1M | | 0.5M | | 1M | |
| surfactant(CTAC) | | | | | | | | |

### Experimental Example 1: Evaluation on Solubility of TEMPO According to CTAC Concentration

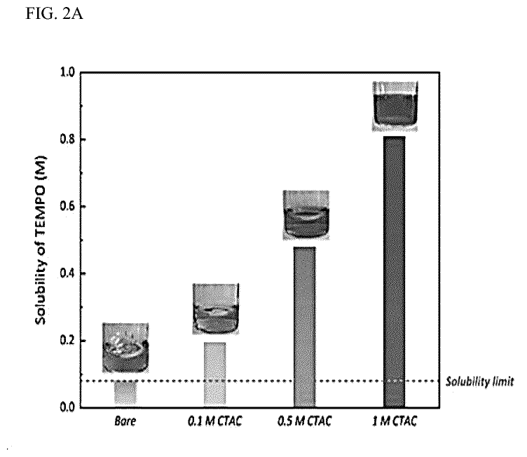

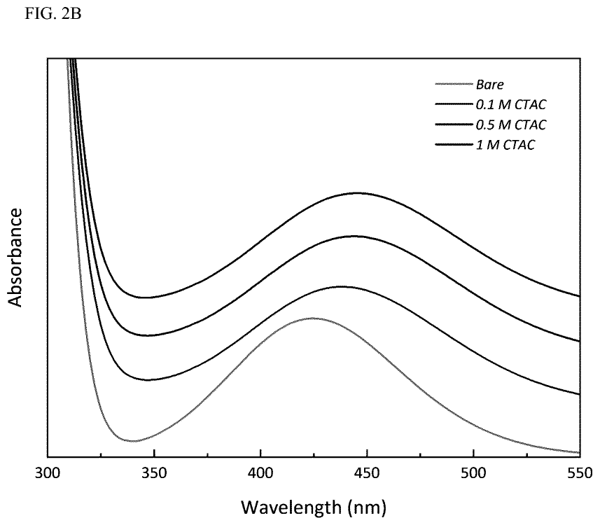

FIG. 2A shows the solubility of TEMPO according to the concentration of CTAC.

Referring to FIG. 2A, it is determined that as the concentration of a surfactant (CTAC) increased to 0.1 M (Example 1), 0.5 M (Example 2), and 1 M (Example 3), the solubility of TEMPO increased up to 0.2, 0.45, and 0.8 M, respectively. Specifically, the electrolyte of Example 3, which had a solubility of 0.8 M, showed a solubility that was about 10 times greater than that of the electrolyte of Comparative Example, which had a solubility of 0.08 M.

TABLE 2

| | Comparative | | | |
|---|---|---|---|---|
| Item | Example | Example 1 | Example 2 | Example 3 |
| Solubility (M) of | 0.08M | 0.2M | 0.45M | 0.8M |
| TEMPO | | | | |

### Experimental Example 2: UV-Vis Spectrum of Micelle-Solubilized TEMPO

### Preparation of Examples 4 to 6

Electrolytes (total volume: 3 mL) according to Examples 4 to 6 in which the concentration of TEMPO was set to 0.02 M and the concentration of CTAC was adjusted to 0.1 M (Example 4), 0.5 M (Example 5), and 1.0 M (Example 6), respectively, were prepared.

FIG. 2B shows the Uv-vis spectrum of TEMPO for electrolytes according to Comparative Example and Examples 4 to 6

Referring to FIG. 2B, the micelle-solubilized TEMPO of Examples 4 to 6 showed a further higher absorption peak at a wavelength of 400 to 500 nm than Comparative Example.

### Experimental Example 3: Evaluation on Electrochemical Activity of Micelle-Solubilized TEMPO

### Preparation of Samples

As a positive electrode electrolyte, the electrolytes according to Comparative Example and Examples 1 to 3 above were used, a glassy carbon electrode was used as a working electrode, a platinum electrode was used as a counter electrode, and Ag/AgCl was used as a reference electrode. When measuring cyclic voltammetry, a potential scanning speed of 100 mV/s was applied.

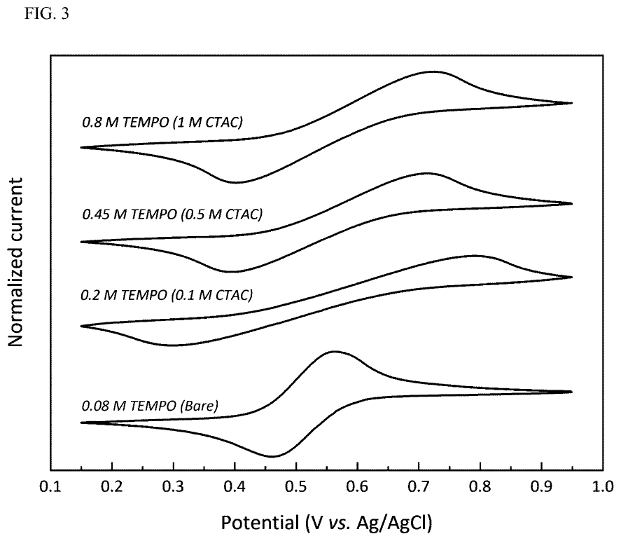

FIG. 3 shows cyclic voltammetry curves according to electrolytes of each of Comparative Example and Examples 1 to 3.

Referring to FIG. 3, it is determined that in Examples 1 to 3, micelle-solubilized TEMPO passes through micelles, which are electrical insulators, and may allow electron transport.

### Preparation Example 2: Preparation of Organic Redox Flow Battery

Carbon paper was used as a positive electrode and a negative electrode, micelle-solubilized TEMPO was used as an organic positive electrode active material, bis(3-trimethylammonio)propyl viologen tetrachloride was used as an organic negative electrode active material, electrolytes according to Comparative Example and Examples 1 to 3 each containing the organic positive electrode active material were used as a positive electrode electrolyte, an aqueous solvent (water) containing the organic negative electrode active material was used as a negative electrode electrolyte, and an anion exchange membrane from Selemion was used as a separator. In this case, the electrolytes were adjusted to have a flow rate of 80 mL/min.

### Experimental Example 3: Evaluation on Performance of Organic Redox Flow Battery

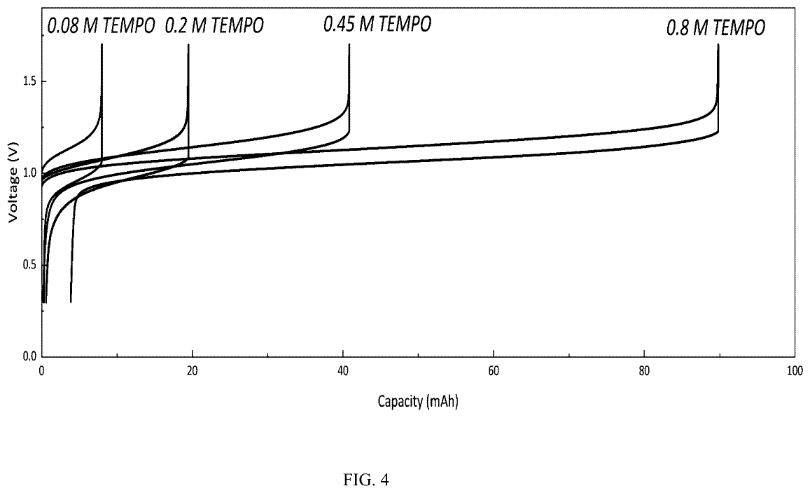

FIG. 4 shows the performance of organic redox flow batteries according to each of Comparative Example and Examples 1 to 3. Specifically, to evaluate the performance of the organic redox flow battery, the capacity of the battery was evaluated in an analysis condition of a current density of 10 mA/cm2 using a WBCS3000 charger/discharger from Wonatech.

Referring to FIG. 4, it is determined that the organic redox flow battery according to Examples 1 to 3 showed significantly higher capacity than Comparative Example. Accordingly, it may be inferred that the TEMPO which is micelle-solubilized through the surfactant has a greater solubility with respect to the electrolyte, thereby further increasing the capacity of the battery.

According to an aspect of the present invention, an electrolyte for an organic redox flow battery, which is capable of increasing the solubility of an organic electrode active material with respect to an electrolyte through micelle solubilization is achievable.

According to another aspect of the present invention, an electrolyte for an organic redox flow battery, which is capable of skipping a complicated synthesis process required when introducing a hydrophilic group into a typical organic electrode active material and significantly reducing manufacturing costs is achievable.

According to yet another aspect of the present invention, an electrolyte for an organic redox flow battery, which is capable of significantly increasing the capacity of a reversible organic redox flow battery is achievable.

In addition to the effects described above, specific effects of the present invention have been described in the above detailed description of the embodiments of the present invention. In addition, the effects of the present invention are not limited to the aforesaid, and may be readily practiced by means recited in the specification and a combination thereof.

While preferred embodiments of the present invention have been described in detail, the invention is not limited to the disclosed embodiments. On the contrary, those skilled in the art will appreciate that various modifications and changes may be made without departing from the spirit and scope of the present invention as set forth in the following claims.

What is claimed is:

1. An electrolyte for an organic redox flow battery, the electrolyte comprising:
an organic electrode active material;
a solvent; and
a surfactant.

2. The electrolyte for an organic redox flow battery of claim 1, wherein the organic electrode active material comprises at least one selected from a 2,2,6,6-tetramethylpiperidin-1-yl)oxyl-based (TEMPO-based) compound, ferrocene, and phenazine.

3. The electrolyte for an organic redox flow battery of claim 2, wherein the TEMPO-based compound comprises at least one selected from the group consisting of 2,2,6,6-tetramethylpiperidin-1-yl)oxyl (TEMPO), 4-methacryloyloxy-2,2,6,6-tetramethylpiperidine-1-oxyl (4-methacryloyloxy TEMPO), 4-amino-2,2,6,6-tetramethylpiperidine-1-oxyl (4-amino TEMPO), 4-acetamido-2,2,6,6-tetramethylpiperidine-1-oxyl (4-acetamido TEMPO), and 4-oxo-2,2,6,6-tetramethylpiperidine-1-oxyl (4-oxo TEMPO).

4. The electrolyte for an organic redox flow battery of claim 1, wherein the organic electrode active material has a solubility of 0.1 M or greater.

5. The electrolyte for an organic redox flow battery of claim 1, wherein the solvent comprises any one selected from the group consisting of an aqueous solvent, a non-aqueous solvent, and a mixture thereof.

6. The electrolyte for an organic redox flow battery of claim 1, wherein the surfactant comprises at least one selected from the group consisting of a cationic surfactant, an anionic surfactant, and a nonionic surfactant.

7. The electrolyte for an organic redox flow battery of claim 1, wherein the surfactant comprises a cationic surfactant.

8. The electrolyte for an organic redox flow battery of claim 7, wherein the cationic surfactant comprises a quaternary ammonium salt.

9. The electrolyte for an organic redox flow battery of claim 1, wherein the surfactant has a concentration of 0.1 M or greater.

10. An organic redox flow battery comprising the electrolyte for an organic redox flow battery according to claim 1.
